(19) United States
(12) Patent Application Publication
(10) Pub. No.: US 2013/0333799 A1
(43) Pub. Date: Dec. 19, 2013

(54) LNG REFUELING SYSTEM AND BOIL-OFF GAS TREATMENT METHOD

(71) Applicants: Dae Jun Chang, Ulsan (KR); Su Won Seo, DaeJeon (KR); Jiheon Ryu, DaeJeon (KR)

(72) Inventors: Dae Jun Chang, Ulsan (KR); Su Won Seo, DaeJeon (KR); Jiheon Ryu, DaeJeon (KR)

(73) Assignee: KOREA ADVANCED INSTITUTE OF SCIENCE AND TECHNOLOGY, Daejeon (KR)

(21) Appl. No.: 14/001,742

(22) PCT Filed: Feb. 28, 2012
(86) PCT No.: PCT/KR12/01486

§ 371 Date: Aug. 27, 2013

(30) Foreign Application Priority Data
Feb. 28, 2011 (KR) 10-2011-0018156
Apr. 11, 2011 (KR) 10-2011-0033289
Apr. 25, 2011 (KR) 10-2011-0038675
Jun. 16, 2011 (KR) 10-2011-0058769

(51) Int. Cl. F17C 5/02

(52) U.S. Cl. CPC F17C 5/02
USPC 141/39

(57) ABSTRACT

Provided is an LNG refueling system which can deliver LNG to an LNG-fueled ship and an LNG-refueled ship or can introduce the LNG from an LNG carrier, and more particularly, an LNG refueling system which separately has a low-temperature LNG tank and a high-temperature LNG tank such that both a low-temperature LNG and a high-temperature LNG can be handled, prevents an increase in pressure in the low-temperature LNG tank, and increases stability, and includes a flashing drum to change a high-temperature LNG to a low-temperature LNG such that both the high-temperature LNG and the low-temperature LNG can be supplied. Further, the present invention relates to an LNG refueling system including a boil-off gas treatment system to facilitate treatment of boil-off gas and a boil-off gas treatment method.

### TECHNICAL FIELD

The present invention relates to an LNG refueling system which can deliver LNG to a liquefied natural gas (LNG)-fueled ship and an LNG-refueled ship or can introduce the LNG from an LNG carrier, and more particularly, to an LNG refueling system which separately has a low-temperature LNG tank and a high-temperature LNG tank such that both a low-temperature LNG and a high-temperature LNG can be handled, prevents an increase in pressure in the low-temperature LNG tank, and has a boil-off gas treatment system to effectively treat the boil-off gas generated during the refueling, and a boil-off gas treatment method for the boil-off gas treatment system.

### BACKGROUND ART

The use of liquefied natural gas (LNG) has been considered as a propulsion fuel of a ship, instead of a diesel fuel discharging a considerable quantity of pollutants.

The LNG, which is liquefied natural gas obtained by liquefying gaseous natural gas, has a volume reduced to 1/600 over that of the gaseous natural gas, such that a large quantity of LNG may be effectively carried.

In general, a refueling facility of a ship or a refueling facility on a land has been used to refuel the LNG to a ship.

As the above-mentioned system, there are a ship (hereinafter, referred to as an ‘LNG-refueled ship’) which is refueled with the LNG and stores the LNG and then refuels the LNG to another ship and a refueling facility (hereinafter, referred to as an ‘LNG refueling terminal’) which stores the LNG carried from an LNG production base and then refuels the LNG to an LNG-fueled ship or an LNG-refueled ship, which is collectively called an LNG refueling system. Further, as the refueling system, there is a ship (hereinafter, referred to as an ‘LNG carrier’) which supplies the LNG.

FIG. 1 is a diagram illustrating a graph representing a change in pressure depending on a temperature of LNG.

Referring to FIG. 1, the above-mentioned LNG has a lower pressure as temperature reduces and a higher pressure as temperature increases and has a pressure within 2 atmospheric pressure at −155° C. A pressure unit of the graph illustrated in FIG. 1 is a bar, in which 1 bar is 1000 hectopascal and 1 atmospheric pressure is 1013.25 hectopascal.

Meanwhile, the LNG-fueled ship or the LNG-refueled ship may request LNG lower than −155° C. which may stably store the LNG or request the LNG equal to or higher than −155° C. at which the fuel efficiency increases.

However, since tanks storing the LNG which are included in a general LNG refueling system are operated between 1.05 and 2.00 atmospheric pressure, there are problems in that tanks which may be operated at 2 atmospheric pressure or more are further required so as to store the LNG equal to or higher than −155° C. and when the tanks storing the LNG less than −155° C. are introduced with heat from the outside to increase the temperature of LNG to −155° C. or more and to increase the pressure to 2 atmospheric pressure or more, the tanks storing the LNG may be damaged.

Further, the LNG is introduced with heat from the outside during the transfer of LNG even when the tank and the tube suffer from heat insulation, the boil-off gas continues to be generated. The boil-off gas means the state change from the liquefied LNG into the gaseous natural gas. Therefore, even though a small quantity of LNG is vaporized to the boil-off gas, the volume occupied by the boil-off gas is relatively larger than that of LNG. When the boil-off gas having the relatively larger volume than that of LNG continues to be generated, a pressure in a ship fuel tank increases and in the worst case, the ship fuel tank may be exploded.

Therefore, when the pressure of the storage tank is larger than a set safety pressure due to the generation of the boil-off gas, the boil-off gas is discharged to the outside of the ship fuel tank. The discharged boil-off gas as described above is discharged to the air, and otherwise, is used as a propulsion fuel of a ship or re-liquefied and then is again transferred to the LNG tank, such that the boil-off gas may be used like the LNG in the LNG tank. To use the boil-off gas discharged as described above, there is a need to collect the generated boil-off gas, and thus a need exists for an LNG refueling system including a system capable of adsorbing and desorbing the boil-off gas.

In the case of the related art, there is a method of installing a re-liquefying apparatus in a tube connecting the LNG refueling system to the LNG-refueled ship or the LNG-fueled ship to withdraw the re-liquefied LNG to the LNG refueling system.

However, the capacity of the re-liquefying apparatus is limited, which causes a problem in that there is a need to discharge the boil-off gas, which is not re-liquefied, to the air.

Therefore, a need exists for an LNG refueling system and a boil-off gas treatment method capable of refueling LNG having temperature and pressure requested by a ship, effectively adsorbing and desorbing a large quantity of boil-off gas, and saving energy consumed for adsorption and desorption.

### DISCLOSURE

### Technical Problem

The present invention proposes to solve the above problems, and an object of the present invention is to provide an LNG refueling system capable of handling both a low-temperature LNG and a high-temperature LNG, preventing an increase in pressure in a low-temperature LNG tank, increasing stability, and effectively treating boil-off gas by allowing the LNG refueling system which can deliver LNG to an LNG-fueled ship and an LNG-refueled ship or can introduce the LNG from an LNG carrier to separately have a low-temperature LNG tank and a high-temperature LNG tank, and a boil-off gas treatment method.

### Technical Solution

In one general aspect, there is provided an LNG refueling system, including: at least one low-temperature LNG tank 100 delivering or introducing LNG from a ship fuel tank 900 on the sea; at least one pressure vessel type high-temperature LNG tank 200 connected to the low-temperature LNG tank 100; and a natural gas compression system 310 compressing natural gas generated from the low-temperature LNG tank 100 due to heat introduced from the outside and transferring the compressed natural gas to the high-temperature LNG tank 200.

Further, the LNG refueling system 1000 may further include: a seventh transfer tube 470 transferring the LNG in the low-temperature LNG tank 100 to the high-temperature LNG tank 200.

Further, an inside of the low-temperature LNG tank 100 may be provided with a first injection apparatus 110 and an inside of the high-temperature LNG tank 200 may be provided with a second injection apparatus.

Further, the LNG refueling system 1000 may further include: a natural gas liquefying system 320 liquefying the natural gas compressed by the natural gas compression system 310.

Further, the LNG refueling system 1000 may further include: when the temperature of the LNG of the high-temperature LNG tank 200 is lower than that of the LNG requested from a ship, an LNG heating system 330 heating the LNG of the high-temperature LNG tank 200.

Further, the LNG refueling system 1000 may further include: when a quantity of the LNG of the low-temperature LNG tank 100 is lower than that of the LNG requested from the ship, an LNG flashing system 340 flashing the LNG in the high-temperature LNG tank 200.

Further, the LNG refueling system 1000 may further include: an inert gas producing system 350 and an inert gas-natural gas separating system 360 connected to the ship fuel tank 900.

Further, the LNG refueling system 1000 may further include: a power producing system 370 connected to the low-temperature LNG tank 100 to combust the natural gas generated from the low-temperature LNG tank 100 so as to convert the combusted natural gas into electricity.

Further, the LNG refueling system 1000 may further include: a fifth transfer tube 450 transferring the LNG from the LNG carrier fuel tank 800 to the low-temperature LNG tank 100 and the high-temperature LNG tank 200 and a sixth transfer tube 460 transferring the natural gas from the LNG carrier fuel tank 800 to the low-temperature LNG tank 100 and the high-temperature LNG tank 200.

Further, the LNG refueling system 1000 may further include: a boil-off gas treatment system 500 treating boil-off gas generated when the LNG is transferred from the low-temperature LNG tank 100 or the high-temperature LNG tank 200 to the ship fuel tank 900.

Further, the boil-off gas treatment system 500 may include: a first boil-off gas transfer tube 510 connected between the low-temperature LNG tank 100 of the high-temperature LNG tank 200 and the ship fuel tank 900 to transfer the boil-off gas generated from the ship fuel tank 900 to the low-temperature LNG tank 100 or the high-temperature LNG tank 200; an injection unit 520 reducing the temperature of the boil-off gas in the low-temperature LNG tank 100 or the high-temperature LNG tank 200; a second boil-off gas transfer tube 530 connected to the low-temperature LNG tank 100 or the high-temperature LNG tank 200 to transfer the temperature-controlled boil-off gas; an adsorbing-desorbing apparatus 540 connected to an end of the second boil-off gas transfer tube 530 and including an adsorbent to selectively adsorb and desorb the boil-off gas; and a third boil-off gas transfer tube 550 transferring the boil-off gas desorbed from the adsorbing-desorbing apparatus 540.

Further, the injection unit 520 may include an injection transfer tube 521 of which the one side is connected to bypass to the low-temperature LNG tank 100 or the high-temperature LNG tank 200 to transfer the LNG in the low-temperature LNG tank 100 or the high-temperature LNG tank 200 and the other side is connected to the first injection apparatus 110 and an injection pump 522 included in the injection transfer tube 521.

Further, the boil-off gas treatment system 500 may include a second compressor 531 disposed on a second boil-off gas transfer tube 530 to control a pressure of the boil-off gas transferred to the adsorbing-desorbing apparatus 540.

Further, the boil-off gas treatment system 500 may further include a first desorbing transfer tube 541 of which both ends are connected to the adsorbing-desorbing apparatus 540 to circulate the boil-off gas and a heating apparatus 542 disposed on the first desorbing transfer tube 541.

Further, the boil-off gas treatment system 500 may include: a cooling apparatus 551 disposed on the third boil-off gas transfer tube 550; and a liquefying apparatus 552 provided at a rear side of the cooling apparatus 551 to liquefy the cooled boil-off gas.

Further, the boil-off gas treatment system 500 may include a vacuum pump 543 disposed in the first desorbing transfer tube 541 to control the pressure in the adsorbing-desorbing apparatus 540 so as to desorb a portion of the boil-off gas adsorbed into the adsorbing-desorbing apparatus 540.

Further, the boil-off gas treatment system 500 may include a second desorbing transfer tube 544 having one side branched from the first desorbing transfer tube 541 and the other side connected to the low-temperature LNG tank 100 or the high-temperature LNG tank 200 and transferring the LNG injected from the injection unit 100 to the heating apparatus 542.

Further, the boil-off gas treatment system 500 may include the third boil-off gas transfer tube 550 branched before the cooling apparatus 551 is provided to transfer the boil-off gas desorbed from the adsorbing-desorbing apparatus 540 to a gas fuel source in the ship.

Further, the boil-off gas treatment system 500 may further include a temporary storage tank 560 disposed on the first boil-off gas transfer tube.

Meanwhile, In another general aspect, there is provided a boil-off gas treatment method using a boil-off gas treatment system 500, including: controlling (S10) a temperature of boil-off gas by injecting LNG in a low-temperature LNG tank 100 or a high-temperature LNG tank 200; adsorbing (S20) the boil-off gas heated in the controlling of the temperature of the boil-off gas (S10) by an adsorbent of an adsorbing-desorbing apparatus 540; preparing desorption (S30) desorbing a portion of the boil-off gas by controlling temperature and pressure of the boil-off gas adsorbed in the adsorbing (S20); and desorbing (S40) the remaining boil-off gas adsorbed by transferring a portion of the desorbed boil-off gas through a second desorption transfer tube 544 and re-introducing the boil-off gas heated by a heating apparatus 542 into the adsorbing-desorbing apparatus 540.

Further, the preparing desorption (S30) may be performed by controlling the pressure of the adsorbing-desorbing apparatus 540 through a vacuum pump 543 disposed in a first desorption transfer tube 541.

Further, the preparing desorption (S30) may be performed by transferring the LNG injected by an injection unit 520 and heated by the heating apparatus 542 through the second desorption transfer tube 544 and controlling the temperature of the adsorbing-desorbing apparatus 540.

Further, the boil-off gas treatment method may further include: after the desorbing (S40), re-liquefying (S50) the cooled boil-off gas by passing the cooled boil-off gas through the liquefying apparatus 552, after a portion or the whole of the desorbed boil-off gas passes through a cooling apparatus 551.

Further, the boil-off gas treatment method may further include: cooling (S60) the adsorbing-desorbing apparatus 540 by moving the LNG injected through the injection unit 520 to the adsorbing-desorbing apparatus 540.

Further, the boil-off gas treatment method may further include: after the desorbing (S40), using a gas fuel source (S70) by transferring a portion or the whole of the desorbed boil-off gas to the gas fuel source.

Further, the boil-off gas treatment method may further include: after the adsorbing (S20), separating apparatus (S80) separating the ship fuel tank 900 from a boil-off treatment system 500 further including a temporary storage tank 560.

### Advantageous Effects

According to the present invention, the LNG refueling system can deliver the LNG to the LNG-fueled ship and the LNG-refueled ship or introduce the LNG from the LNG carrier to supply the LNG having the temperature requested by the ship, prevent the increase in pressure of the low-temperature LNG tank, and increase the stability.

Further, the LNG refueling system according to the present invention can easily use the LNG as the fuel without controlling the pressure of LNG in the ship and control the pressure of LNG before the LNG is introduced to the inside of the ship to remove a need to separately include the pressure control apparatus in the ship, thereby simplifying the apparatus.

In addition, the LNG refueling system according to the present invention includes the boil-off gas treatment system to effectively carry out the adsorption and desorption of the boil-off gas, thereby increasing the reuse efficiency of the boil-off gas.

Moreover, the LNG refueling system according to the present invention includes a temporary storage tank which temporarily stores the boil-off gas in the first boil-off gas transfer tube to remove the need to manufacture the fuel tank of the supply line in a pressurization type, liquefy the whole boil-off gas, and discharge the boil-off gas to the air, thereby implementing the economical, eco-friendly LNG refueling system.

### DESCRIPTION OF DRAWINGS

The above and other objects, features and advantages of the present invention will become apparent from the following description of preferred embodiments given in conjunction with the accompanying drawings, in which:

FIG. 1 is a graph illustrating a change in pressure depending on a temperature of LNG;

FIG. 2 is a schematic diagram illustrating a path transferring natural gas in a low-temperature LNG tank, which is compressed by a natural gas compression system, to a high-temperature LNG tank, in the LNG refueling system according to the present invention;

FIG. 3 is a schematic diagram illustrating a path transferring a low-temperature LNG of the low-temperature LNG tank or an LNG flashing system to the high-temperature LNG tank through a first transfer tube, in the LNG refueling system according to the present invention;

FIG. 4 is a schematic diagram illustrating a path in which the natural gas generated from the low-temperature LNG tank of the LNG refueling system according to the present invention is liquefied by the natural gas compression system and a natural gas liquefying system;

FIG. 5 is a schematic diagram illustrating a path delivering the high-temperature LNG to a ship fuel tank in the LNG refueling system according to the present invention;

FIG. 6 is a schematic diagram illustrating a path delivering the low-temperature LNG to the ship fuel tank in the LNG refueling system according to the present invention;

FIG. 7 is a schematic diagram illustrating a path refueling inert gas, natural gas, and LNG to the ship fuel tank filled with air immediately after being dried and maintained and repaired in the LNG refueling system according to the present invention;

FIG. 8 is a schematic diagram illustrating a path producing power with vapor generated from the LNG refueling system according to the present invention;

FIG. 9 is a schematic diagram illustrating a path introducing the LNG from the LNG carrier in the LNG refueling system according to the present invention;

FIG. 10 is a schematic diagram illustrating a path transferring an exhaust gas generated when a pressure of the tank and the system abnormally increases due to heat introduced from the outside in the LNG refueling system according to the present invention;

FIG. 11 is a schematic diagram illustrating a path transferring natural gas generated at the time of producing the low-temperature LNG by passing the high-temperature LNG through the LNG flashing system in the LNG refueling system according to the present invention;

FIG. 12 is a schematic diagram illustrating an embodiment of the LNG flashing system in the LNG refueling system according to the present invention;

FIG. 13 is a schematic diagram illustrating a boil-off gas treatment system of the LNG refueling system according to the present invention;

FIG. 14 is a schematic diagram illustrating an apparatus used during an adsorption process in the boil-off gas treatment system of the LNG refueling system according to the present invention;

FIG. 15 is a schematic diagram illustrating an apparatus used during a desorption process in the boil-off gas treatment system of the LNG refueling system according to the present invention;

FIG. 16 is a schematic diagram illustrating that a second desorption transfer tube is further included in the boil-off gas treatment system of the LNG refueling system according to the present invention;

FIG. 17 is a schematic diagram illustrating that a cooling apparatus and a liquefying apparatus are further included in the boil-off gas treatment system of the LNG refueling system according to the present invention;

FIG. 18 is a schematic diagram illustrating that a temporary storage tank is further included in the boil-off gas treatment system of the LNG refueling system according to the present invention;

FIG. 19 is a process diagram illustrating a boil-off gas treatment method according to the present invention;

FIG. 20 is a process diagram illustrating that a re-liquefying process is carried out after the desorption process in the boil-off gas treatment method according to the present invention;

FIG. 21 is a process diagram illustrating that an apparatus cooling process is carried out after the desorption process in the boil-off gas treatment method according to the present invention;

FIG. 22 is a process diagram illustrating that a process of using a gas fuel source is carried out after the desorption process in the boil-off gas treatment method according to the present invention; and

FIG. 23 is a process diagram illustrating that an apparatus separation process is carried out after the desorption process in the boil-off gas treatment method according to the present invention.

### BEST MODE

Hereinafter, a technical spirit of an LNG refueling system according to the present invention will be described in more detail with reference to the accompanying drawings.

However, the accompanying drawings are only examples shown in order to describe the technical idea of the present invention in more detail. Therefore, the technical idea of the present invention is not limited to shapes of the accompanying drawings.

The present invention relates to an LNG refueling system which may deliver LNG to an LNG-fueled ship using the LNG as a fuel and an LNG-refueled ship supplied with the LNG and storing the LNG and then refueling the LNG to another ship or introduce the LNG from an LNG carrier carrying and supplying the LNG of the LNG production base. An LNG refueling system 1000 separately has a low-temperature LNG tank 100 storing a low-temperature LNG and a high-temperature LNG tank 200 storing a high-temperature LNG to be able to handle both the low-temperature and the high-temperature LNG, prevent the increase in pressure of the low-temperature LNG tank 100, and increase stability. In this case, the low-temperature LNG is LNG less than −155° C. and the high-temperature LNG is LNG equal to or higher than −155° C.

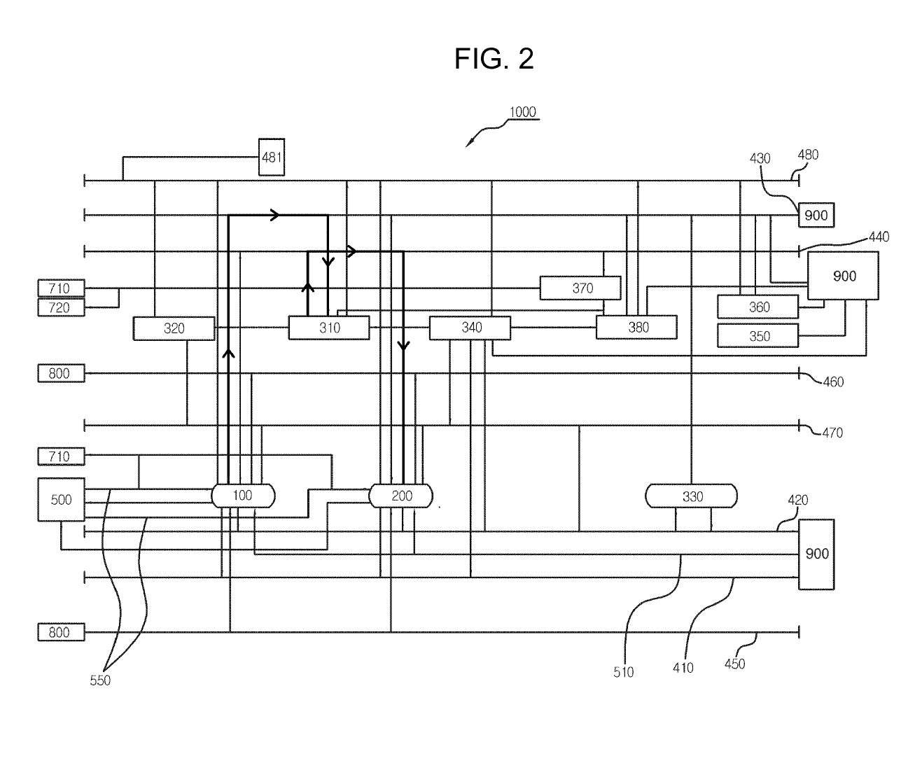

FIG. 2 is a diagram illustrating a path transferring natural gas in the low-temperature LNG tank 100, which is compressed by a natural gas compression system 310, to the high-temperature LNG tank 200, in the LNG refueling system 1000 according to the present invention. The LNG refueling system 100 according to one embodiment of the present invention will be described in more detail with reference to FIG. 2.

The LNG refueling system 1000 according to the present invention includes at least one low-temperature LNG tank 100 and at least one pressure vessel type high-temperature LNG tank 200 which deliver the LNG to a ship fuel tank 900 of the LNG-fueled ship and the LNG-refueled ship on the sea or introduce the LNG from an LNG carrier fuel tank 800 of the LNG carrier and may include a system and a main tube capable of increasing the LNG delivery, the introduction efficiency, and the stability.

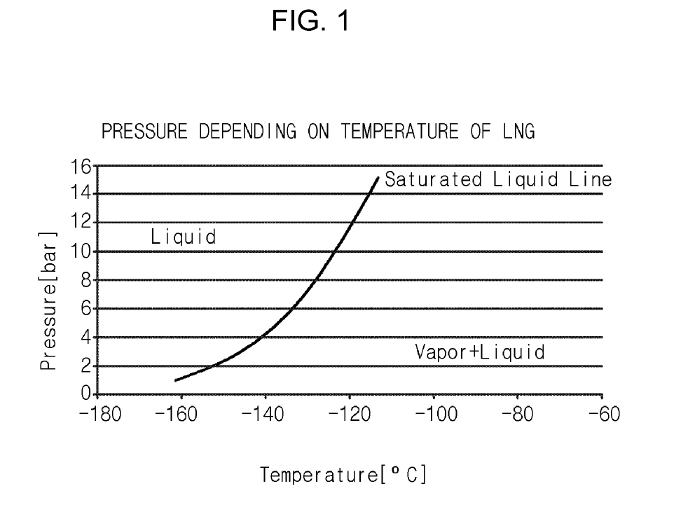

In general, as a storage tank of LNG, a low-pressure tank operated between 1.05 and 2.00 atmospheric pressure is used and the low-temperature LNG tank 100 is a low-pressure tank. FIG. 1 is a graph illustrating a change in pressure depending on a temperature of LNG and referring to FIG. 1, the LNG has a pressure within 2.00 atmospheric pressure at temperature less than −155° C. The LNG-fueled ship and the LNG-refueled ship may request the low-temperature LNG less than −155° C. which may be stored in the tank operated between 1.05 and 2.00 atmospheric pressure and request the high-temperature LNG equal to or higher than −155° C. showing high fuel efficiency when the LNG is used as a fuel and since the LNG has a lower pressure as temperature reduces and a higher pressure as temperature increases in consideration of characteristics of LNG, the LNG refueling system 1000 includes the low-temperature LNG tank 100 which may store the LNG less than −155° C. and within 2.00 atmospheric pressure and the pressure vessel type high-temperature LNG tank 200 which may store the LNG higher than −155° C. and equal to or higher than 2.00 atmospheric pressure. Further, the LNG refueling system 1000 needs to be sealed to prevent the natural gas from being mixed with air at the time of delivering or introducing the LNG.

Since the low-temperature LNG tank 100 as described above has the difference in pressure depending on the temperature under a composition condition of LNG, the low-temperature LNG tank is preferably set to have a design pressure of 2.50 atmospheric pressure higher than 2.00 atmospheric pressure. In this case, the pressure is an absolute pressure.

Referring to FIG. 2, the LNG refueling system 1000 may include a natural gas compression system 310, a natural gas liquefying system 320, an LNG heating system 330, an LNG flashing system 340, an inert gas producing system 350, an inert gas-natural gas separating system 360, a power producing system 370, and an LNG boiling-off system 380, and a boil-off gas treatment system 500.

The natural gas compression system 310 may compress the natural gas using a high-pressure compressor, the natural gas liquefying system 320 may liquefied the natural gas by exchanging heat several times using a mixed refrigerant, and the LNG heating system 330 may increase the temperature of LNG by exchanging heat. The LNG flashing system 340 flashes (a method of obtaining a low-temperature liquid after reducing a pressure of a high-temperature saturated liquid through a valve or a nozzle and generating vapor during a flashing process) the high-temperature LNG to be able to produce the low-temperature LNG, the inert gas producing system 350 may use an inert gas generator (IGG) producing the inert gas, and the inert gas-natural gas separating system 360 may use a nature of first liquefying gas having high boiling point by cooling the inert gas and the natural gas or may separate the inert gas from the natural gas by sorting and distilling the inert gas and the natural gas after liquefying the inert gas and the natural gas. In this case, the LNG flashing system 340 flashes the high-temperature LNG to produce the low-temperature LNG and generate the natural gas. The power producing system 370 may combust the natural gas obtained by vaporizing the LNG due to the increase in pressure and temperature to produce power and the LNG boiling-off system 380 may heat and boil-off the LNG to produce the natural gas. Further, the boil-off gas treatment system 500 may reuse the boil-off gas generated during the refueling.

The main tube 400 includes a first transfer tube 410, a second transfer tube 420, a third transfer tube 430, a fourth transfer tube 440, a second transfer tube 450, a third transfer tube 460, a seventh transfer tube 470, and an eighth transfer tube 480.

The first transfer tube 410 may deliver the low-temperature LNG to the ship fuel tank 900 of the LNG-fueled ship and the LNG-refueled ship and the second transfer tube 420 may deliver the high-temperature LNG to the ship fuel tank 900 of the LNG-fueled ship and the LNG-refueled ship. The third transfer tube 430 may transfer only the low-pressure natural gas and the fourth transfer tube 440 may transfer only the high-pressure natural gas. The second transfer tube 450 and the third transfer tube 460 are a tube which introduces the LNG from the LNG carrier fuel tank 800 and may deliver the natural gas to the LNG carrier fuel tank 800 of the LNG carrier through the third transfer tube 460 as much as a volume of the introduced LNG while introducing the LNG from the LNG carrier fuel tank 800 into the second transfer tube 450. Further, the seventh transfer tube 470 and the second transfer tube have a first injection apparatus 110 and a second injection apparatus disposed at the respective ends thereof to inject the introduced LNG and the eighth transfer tube 480 may deliver the exhaust gas generated when the pressure of the tanks 100 and 200 and the systems 310, 320, 340, 360, and 380 increases due to heat introduced from the outside. In this case, the eighth transfer tube 480 may be provided with a combustion apparatus 481 which combusts the exhaust gas delivered from the tank and the system.

Since the LNG-fueled ship or the LNG-refueled ship may request the low-temperature LNG or request the high-temperature LNG, the LNG refueling system 1000 includes the low-temperature LNG tank 100 and the high-temperature LNG tank 200. The LNG refueling system 1000 as described above increases the pressure and temperature of the low-temperature LNG tank 100 due to the heat introduced from the outside to generate the natural gas in the low-temperature LNG tank 100 and the natural gas generated from the low-temperature LNG tank 100 is transferred and compressed to the natural gas compression system 310 through the third transfer tube 410 and then is transferred to the high-temperature LNG tank 200 through the fourth transfer tube 420. The above-mentioned structure prevents an increase in pressure of the low-temperature LNG tank 100, thereby preventing the low-temperature LNG tank 100 from being damaged.

The LNG refueling system 1000 may include the plurality of low-temperature LNG tank 100 and the plurality of pressure vessel type high-temperature LNG tanks 200 so as to refuel the LNG to the plurality of LNG-fueled ships or LNG-refueled ships for a short period of time.

The LNG refueling terminal may be a bottom-mounted type which is fixed to a ground or a floating type and the LNG refueling system 1000 is applied to the LNG refueling terminal and the LNG-refueled ship.

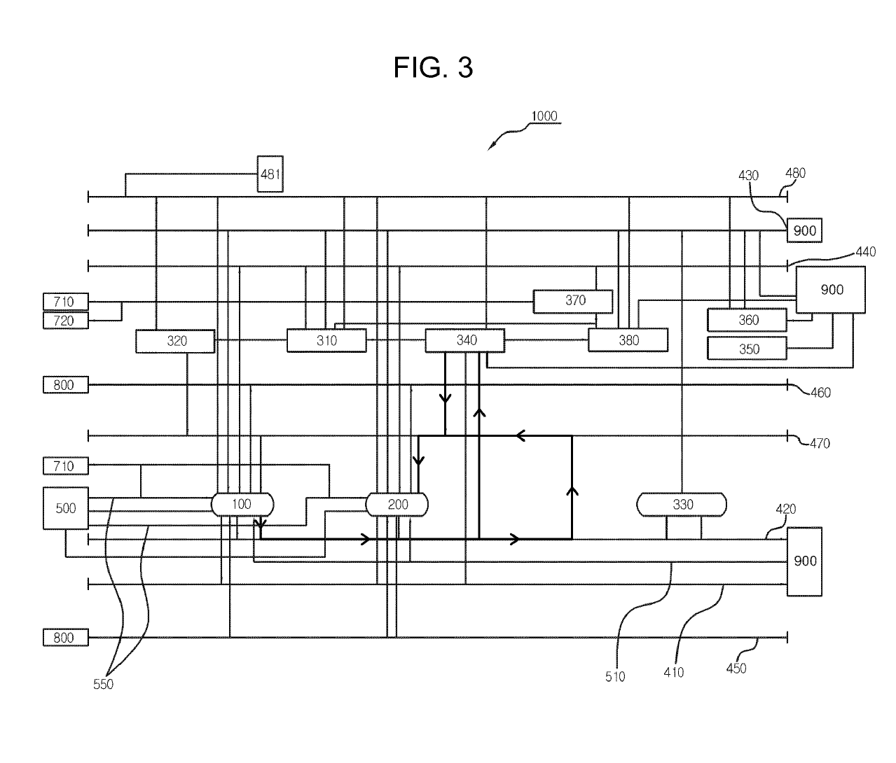

FIG. 3 is a schematic diagram illustrating a path injecting the low-temperature LNG of the low-temperature tank 100 or an LNG flashing system 340 to the high-temperature LNG tank 200 through the seventh transfer tube 470, in the LNG refueling system 1000 according to the present invention, and the process of producing the high-temperature LNG will be described with reference to FIG. 3.

The LNG refueling system 1000 may transfer the LNG of the low-temperature LNG tank 100 to the seventh transfer tube 470 through the second transfer tube 420 and inject the LNG of the low-temperature LNG tank 100 to the high-temperature LNG tank 200 through the seventh transfer tube 470. To prevent the increase in pressure of the low-temperature LNG tank 100, the LNG may be transferred to the high-temperature LNG tank. Since the introduced area of the LNG into the high-temperature LNG tank 200 increases by injecting the LNG through the seventh transfer tube 470, the LNG has the reduced pressure by being introduced into the high-temperature LNG tank 200, such that the LNG may be effectively adsorbed into the high-temperature LNG tank 200. In this case, the LNG of the low-temperature LNG tank 100 is flashed in the LNG flashing system 340 through the second transfer tube 420 and then may be injected to the high-temperature LNG tank 200 through the seventh transfer tube 470.

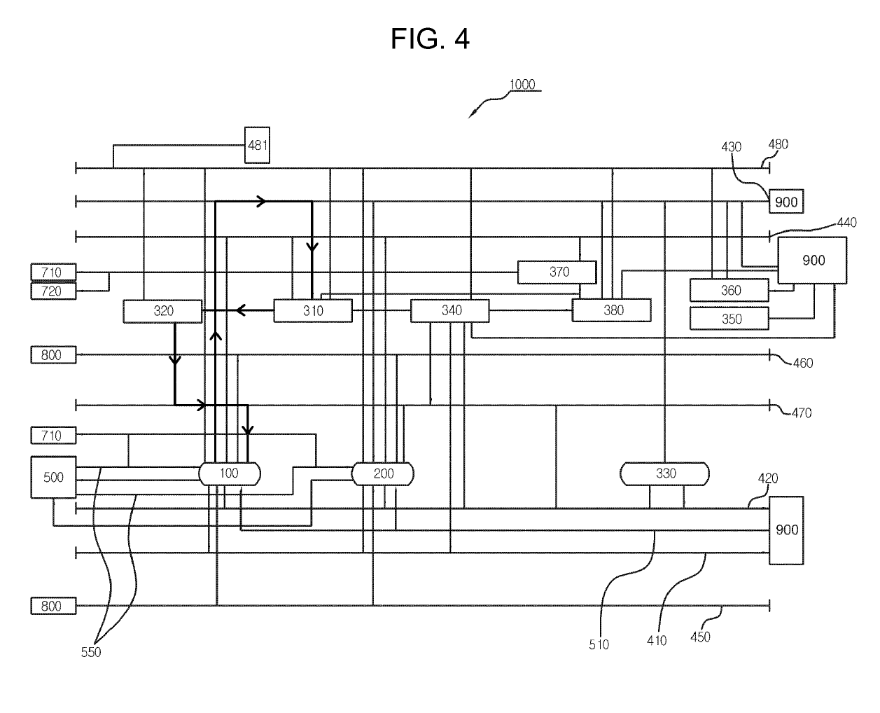

FIG. 4 is a schematic diagram illustrating a path in which the natural gas generated from the low-temperature LNG tank 100 of the LNG refueling system 1000 according to the present invention is liquefied by the natural gas compression system 310 and the natural gas liquefying system 320 and referring to FIG. 4, the pressure and temperature of the low-temperature LNG tank 100 increase due to the heat introduced from the outside, such that the natural gas generated from the low-temperature LNG tank 100 may be compressed by the natural gas compression system 310 through the third transfer tube 430, liquefied by the natural gas liquefying system 320, and then transferred to the low-temperature LNG tank 100 through the seventh transfer tube 470. The LNG refueling system 1000 having the above-mentioned structure may compress the natural gas of the low-temperature LNG tank 100 and then liquefy the compressed natural gas, thereby indirectly reducing the pressure of the low-temperature LNG tank 100.

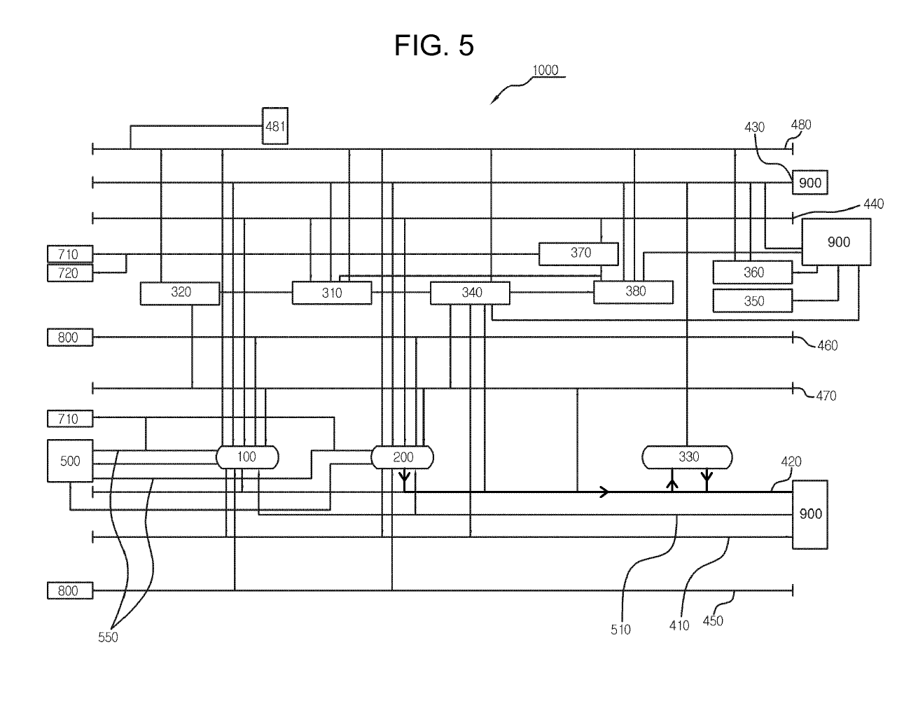

FIG. 5 is a schematic diagram illustrating a path delivering the high-temperature LNG to a ship in the LNG refueling system 1000 according to the present invention and referring to FIG. 5, in the LNG refueling system 1000, the LNG of the high-temperature LNG tank 200 adsorbs a large quantity of natural gas generated from the low-temperature LNG tank 100 to prevent the increase in pressure of the low-temperature LNG tank 100 when the high-temperature LNG is delivered to the LNG-fueled ship, and thus the LNG of the high-temperature LNG tank 200 is delivered through the second transfer tube 420 as it is when the high-temperature LNG satisfies the temperature condition of the high-temperature LNG. In this case, when the LNG of the high-temperature LNG tank 200 does not satisfy the temperature condition of the high-temperature LNG, the LNG of the high-temperature LNG tank 200 may be heated by the LNG heating system 330 included in the second transfer tube 420 and then delivered. The LNG refueling system 1000 as described above may deliver the high-temperature LNG to the LNG-fueled ship requesting the high-temperature LNG by meeting the temperature condition of the high-temperature LNG even though the LNG of the high-temperature LNG tank 200 does not satisfy the temperature condition of the high-temperature LNG.

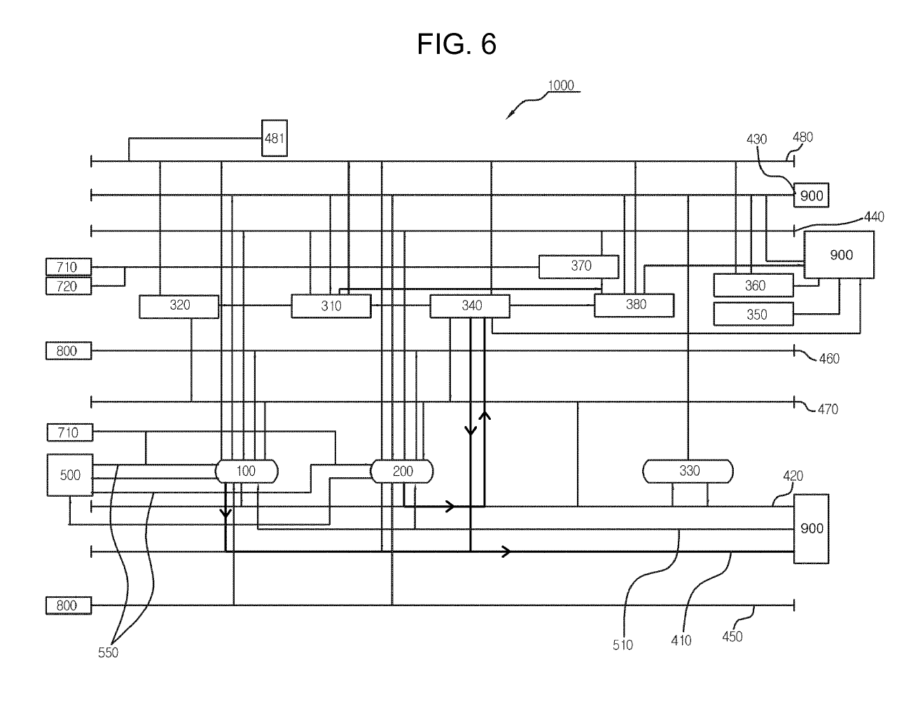

FIG. 6 is a schematic diagram illustrating a path delivering the low-temperature LNG to the ship in the LNG refueling system 1000 according to the present invention and referring to FIG. 6, in the LNG refueling system 1000, when the low-temperature LNG is delivered to the LNG-fueled ship, if the low-temperature LNG of the low-temperature LNG tank 100 is sufficient as much as a quantity requested by the LNG-fueled ship, the low-temperature LNG of the low-temperature LNG tank 100 is delivered through the first transfer tube 410. In this case, when the low-temperature LNG of the low-temperature LNG tank 100 is not sufficient as much as a quantity requested by the LNG-fueled ship, the high-temperature LNG of the high-temperature LNG tank is transferred to the LNG flashing system 340 through the second transfer tube 420 and thus the low-temperature LNG is produced by passing through the flashing process. As described above, the low-temperature LNG produced by passing the high-temperature LNG through the flashing process in the LNG flashing system 340 may be supplied to the LNG-fueled ship through the first transfer tube 410. The LNG refueling system 1000 as described above may supply the low-temperature LNG as much as the quantity requested by the LNG-fueled ship even though the quantity of the low-temperature LNG stored in the low-temperature LNG tank 100 is not sufficient as much as the quantity of the low-temperature LNG requested by the LNG-fueled ship.

As described above, in the LNG refueling system 1000, when the LNG is delivered to the LNG-fueled ship or the LNG-refueled ship, the natural gas of the LNG-fueled ship may be introduced into the LNG refueling system 1000 through the third transfer tube 430 as much as the volume of the delivered LNG.

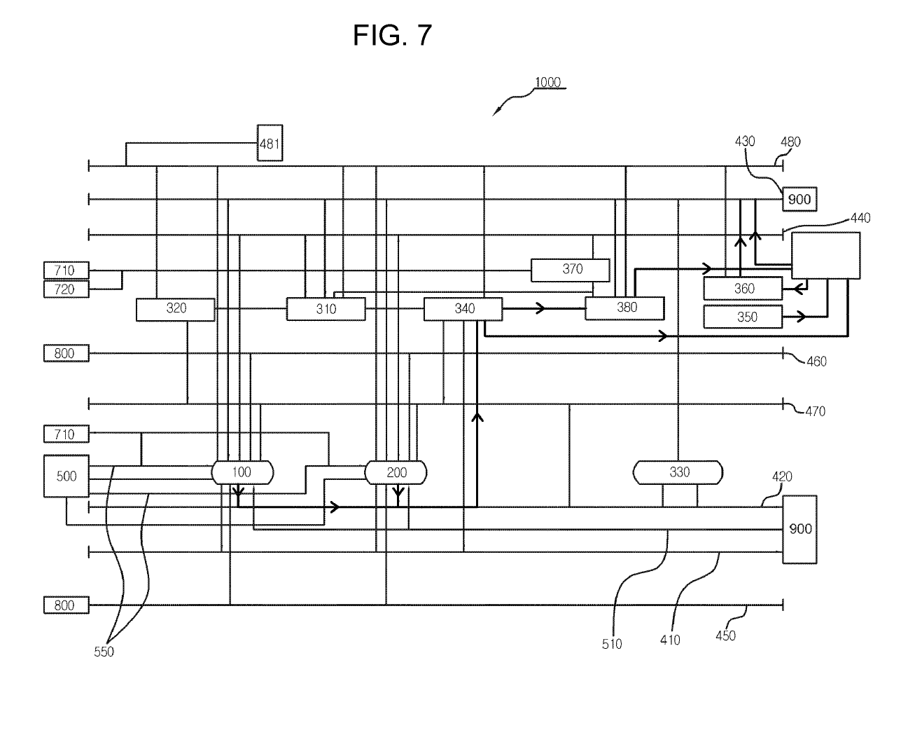

FIG. 7 is a schematic diagram illustrating a path refueling inert gas, natural gas, and LNG to the ship fuel tank 900 filled with air immediately after being dried and maintained and repaired in the LNG refueling system 1000 according to the present invention, and referring to FIG. 7, the LNG refueling system 1000 may include the inert gas producing system 350 and the inert gas-natural gas separating system 360 connected to the ship fuel tank 900 of the LNG-fueled ship or the LNG-refueled ship and the LNG flashing system 340 may produce an ultralow temperature LNG less than −160° C., which is in turn delivered to the ship fuel tank 900 of the LNG-fueled ship. When the ship fuel tank 900 of the LNG-fueled ship or the LNG-refueled ship is about to be dried or suffers from large repairs, the ship fuel tank 900 is filled with a normal-temperature and normal-pressure air. When the natural gas is delivered to a space filled with the normal-temperature and normal-pressure air, the natural gas is coupled with air. Therefore, the LNG refueling system 1000 includes the inert gas producing system 350 to carry out an operation of replacing the air of the LNG-fueled ship or the LNG-refueled ship fuel tank 900 with the inert gas which is not coupled with other elements and replacing the inert gas with the natural gas. To carry out the above-mentioned process, an operation to allow the inert gas producing system 350 to produce the inert gas, supply the generated inert gas to the ship fuel tank 900 of the LNG-fueled ship or the LNG-refueled ship, and then replace the inert gas with the natural gas is carried out. In this case, the natural gas introduced into the ship fuel tank 900 of the LNG-fueled ship or the LNG-refueled ship may be natural gas obtained by allowing the LNG flashing system 340 to flash the LNG of the low-temperature LNG tank 100 or the high-temperature LNG tank 200 passing through the second transfer tube 420 and then the LNG boiling-off system to boil-off the flashed LNG and the natural gas is separated from the inert gas of the ship fuel tank 900 of the LNG-fueled ship or the LNG-refueled ship by using the inert gas-natural gas separating system 360. By the above-mentioned process, when the operation to replace the inert gas of the ship fuel tank 900 of the LNG-fueled ship or the LNG-refueled ship with the natural gas is completed, the ship fuel tank 900 of the LNG-fueled ship or the LNG-refueled ship may be cooled by delivering the ultralow temperature LNG less than −160° C. in the low-temperature LNG produced from the LNG flashing system 340 to the ship fuel tank 900 of the LNG-fueled ship or the LNG-refueled ship.

In general, the storage tank of LNG keeps −163° C. Therefore, when the temperature of the ship fuel tank 900 of the LNG-fueled ship or the LNG-refueled ship is equal to or higher than −163° C., the temperature of the ship fuel tank 900 of the LNG-fueled ship or the LNG-refueled ship may be reduced by using the ultralow temperature LNG less than −160° C. lower than the low-temperature LNG of −163° C.

During the above process, the natural gas filling the ship fuel tank 900 of the LNG-fueled ship and the LNG-refueled ship may be delivered to the third transfer tube 430 as much as the volume of the ultralow temperature LNG which is delivered from the LNG flashing system 340 to the ship fuel tank 900 of the LNG-fueled ship.

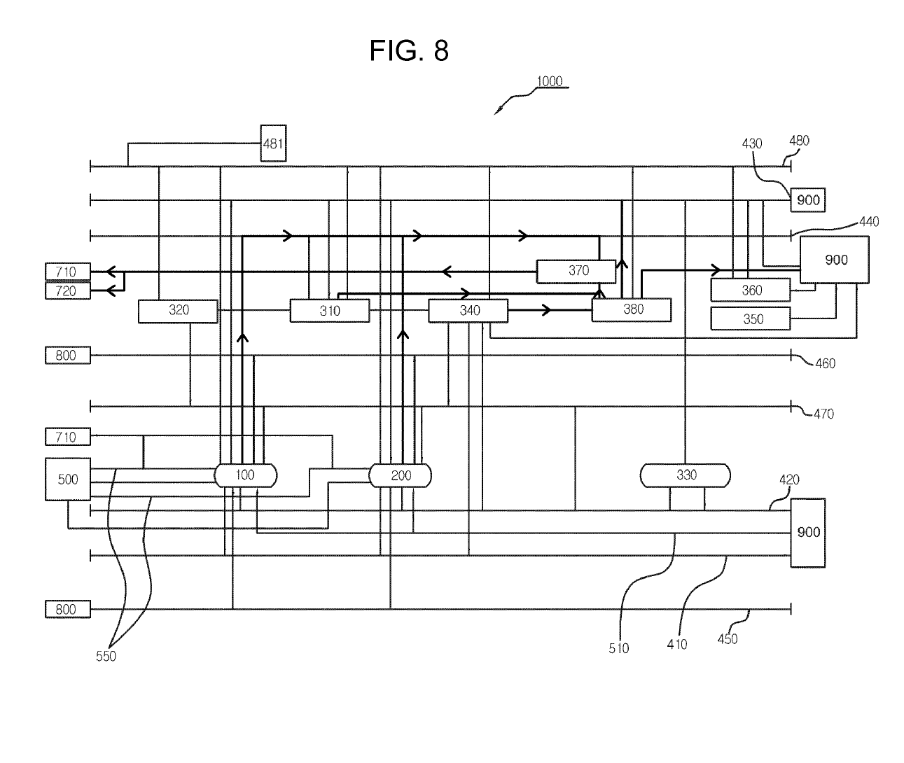

FIG. 8 is a schematic diagram illustrating a path producing power with vapor generated from the LNG refueling system 1000 according to the present invention, and referring to FIG. 8, the natural gas generated from the low-temperature LNG tank 100 is transferred to and combusted in the power producing system 370 through the fourth transfer tube 440 and is converted into electricity, which may be in turn transmitted to an internal power consumption source 710 and an external power consumption source 720. The above-mentioned structure uses the vapor of the low-temperature LNG tank 100 to produce power, thereby preventing the increase in pressure of the low-temperature LNG tank 100 and producing and supplying power. Further, the above-mentioned structure is also used as a pressure rising prevention apparatus of the low-temperature LNG tank 100 and is provided in proportion to the number of low-temperature LNG tanks 100 and may reduce the number of high-temperature LNG tanks 200, which is formed in a pressure vessel type, to reduce a burden on the cost of equipment. The above-mentioned power producing system 370 may use the natural gas introduced into the fourth transfer tube 440 from the high-temperature LNG tank 200 and may also use the natural gas compressed by the natural gas compression system 310 when the pressure of the fourth transfer tube 440 is not sufficient and the natural gas compression system 310 is operated and when the pressure of the high-temperature natural gas main tube 440 is not sufficient and the natural gas compression system 310 is not operated, the low-temperature LNG flashed by the LNG flashing system 340 is boiled-off by the LNG boiling-off system 380 and may be supplied to the power producing system 370. In this case, the low-pressure natural gas generated when the LNG boiling-off system 380 boils-off the LNG may be transferred to the third transfer tube 430 or may be delivered to the LNG-fueled ship or the LNG-refueled ship.

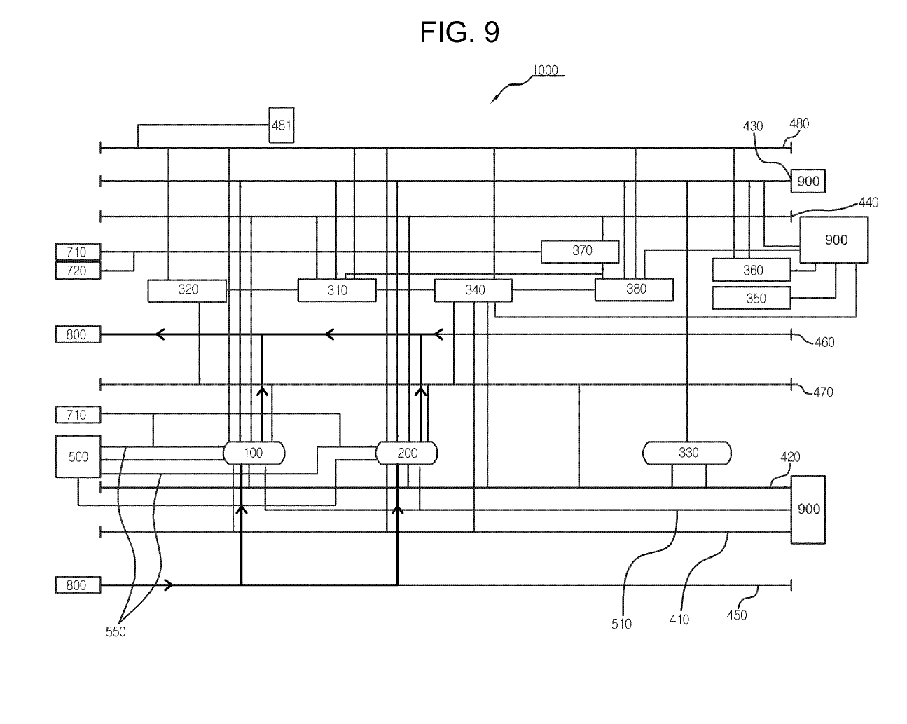

FIG. 9 is a schematic diagram illustrating a path introducing the LNG from the LNG carrier in the LNG refueling system 1000 according to the present invention, and referring to FIG. 9, in the LNG refueling system 1000 the second transfer tube 450 and the third transfer tube 460 installed to introduce the LNG from the LNG carrier fuel tank 800 of the LNG carrier may be connected only to the low-temperature LNG tank 100 and the high-temperature LNG tank 200. The above-mentioned structure removes factors of increasing the pressure of the ship fuel tank 900 of the LNG-refueled ship since the ship fuel tank 900 of the LNG-refueled ship is a low-pressure tank, thereby increasing the stability.

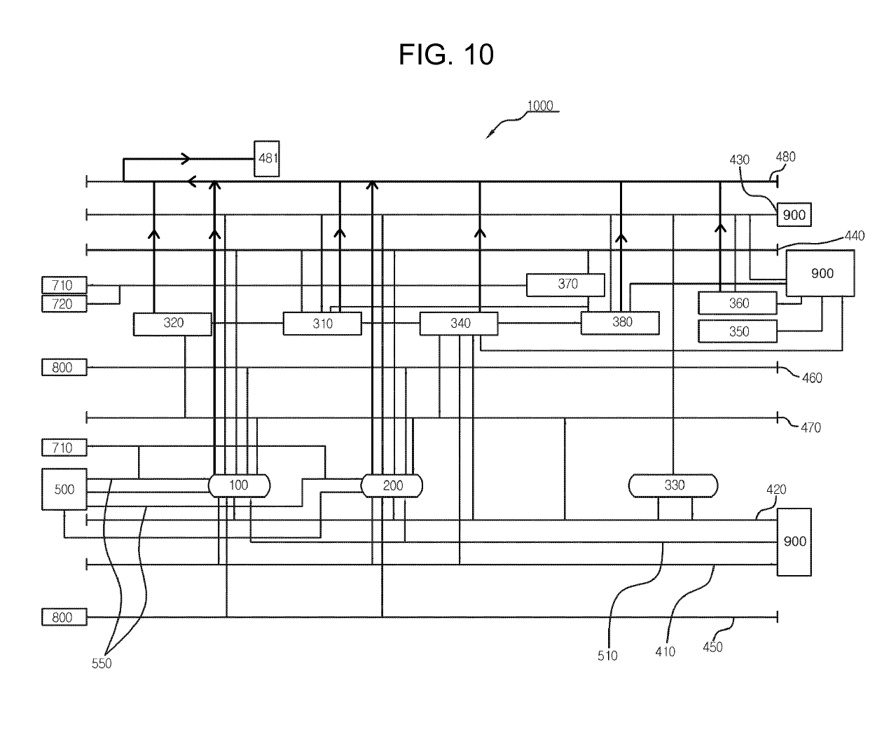

FIG. 10 is a schematic diagram illustrating a path transferring the natural gas generated when the pressure of the tanks 100 and 200 and the systems 310, 320, 340, 360, 380, and 500 increases abnormally due to the heat introduced from the outside in the LNG refueling system 1000 according to the present invention, and referring to FIG. 10, the exhaust gas generated from the low-temperature LNG tank 100, the high-temperature LNG tank 200, the natural gas compression system 310, the natural gas liquefying system 320, the LNG flashing system 340, the inert gas-natural gas separating system 360, and the LNG boiling-off system 380 of the LNG refueling system 1000 as described above is transferred to the eighth transfer tube 480 and the exhaust gas of the eighth transfer tube 480 may be combusted by the combustion apparatus 481 without being emitted to the outside.

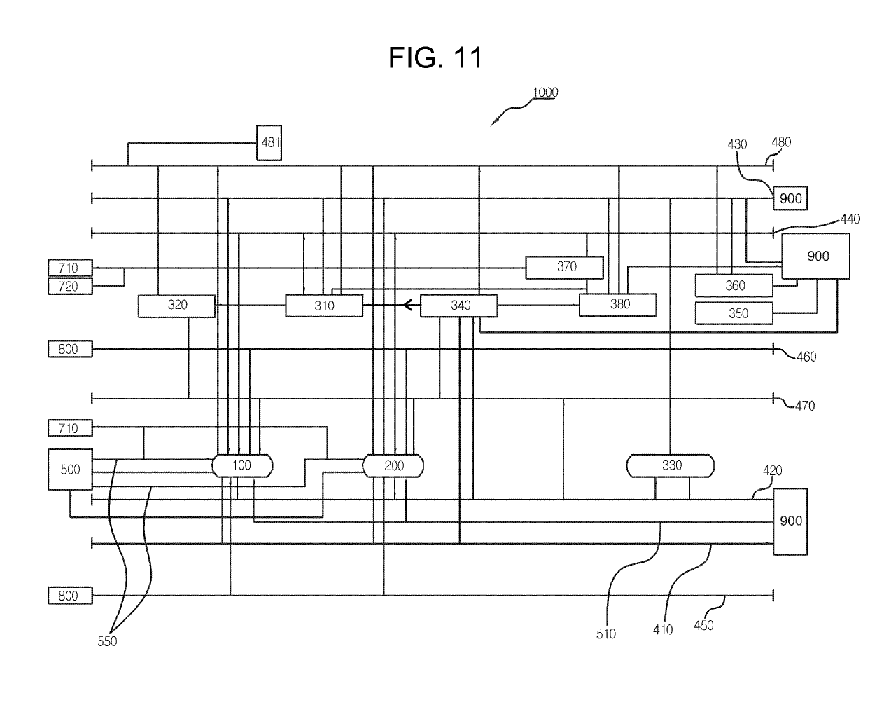

FIG. 11 is a schematic diagram illustrating an embodiment of the LNG flashing system 340 in the LNG refueling system 1000 according to the present invention and referring to FIG. 11, the natural gas generated during the process of allowing the LNG flashing system 340 to perform the flashing process on the high-temperature LNG to produce the low-temperature LNG may be transferred to and compressed in the natural gas compression system 310.

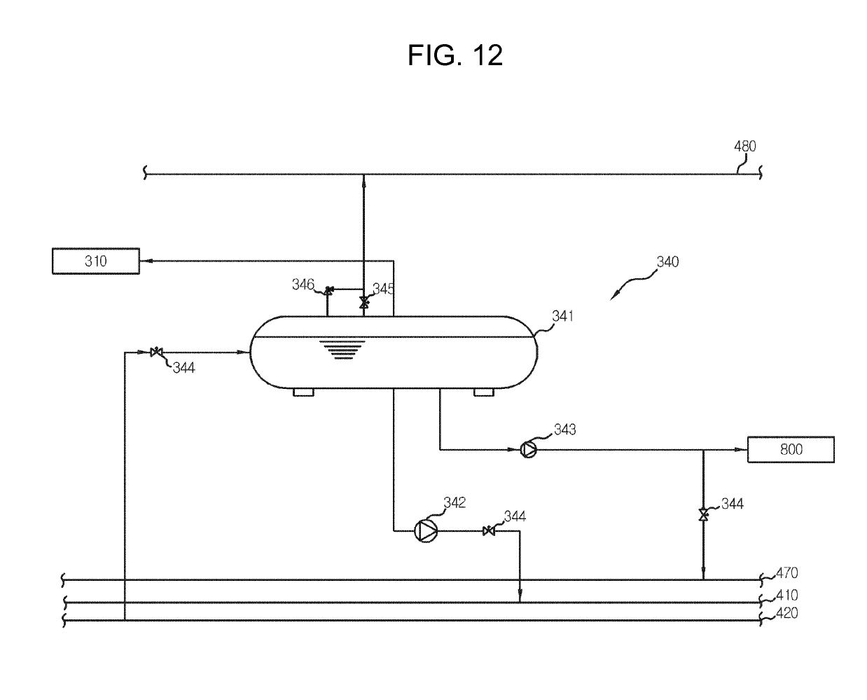

Hereinafter, referring to FIG. 12, the embodiment of the LNG flashing system 340 included in the LNG refueling system 1000 will be described in detail.

Referring to FIG. 12, the LNG flashing system 340 which may store the low-temperature LNG includes a flashing drum 341 which is supplied with the high-temperature LNG from the second transfer tube 420. When the high-temperature LNG is flashed to produce the low-temperature LNG, the low-temperature LNG is transferred to the first transfer tube 410 through a low-temperature LNG supplying pump 342 or is transferred to the LNG-fueled ship or the seventh transfer tube 470 through the flash LNG pump 343. Further, the vapor during the flashing process may be also transferred to the natural gas compression system 310. In this case, each channel may be provided with valves 344 so that the LNG flashing system 340 may control the transfer of the LNG and the natural gas. In this case, the exhaust gas generated during the process of flashing the high-temperature LNG of the flashing drum 341 may be transferred to the eighth transfer tube 480. In this case, the channel through which the exhaust gas is transferred may be provided with a pressure control valve (PCV) 345 which controls pressure in an oil pressure or air pressure circuit and may be provided with a pressure safety valve 346 to divide the pressure to prevent the LNG flashing system 340 from being damaged when the exhaust gas reaches a set pressure or more.

The LNG refueling system 1000 as described above may deliver the LNG to the ship fuel tank 900 of the LNG-fueled ship and the LNG-refueled ship or introduce the LNG from the LNG carrier fuel tank 800 of the LNG carrier, handle both the low-temperature LNG and the high-temperature LNG, prevent the increase in pressure of the low-temperature LNG tank 100, and increase the stability.

As illustrated in FIG. 2, the low-temperature LNG stored in the low-temperature LNG tank 100 is refueled to the ship fuel tank 900 through the first transfer tube 400 and the boil-off gas is generated from the ship fuel tank 900 during the refueling.

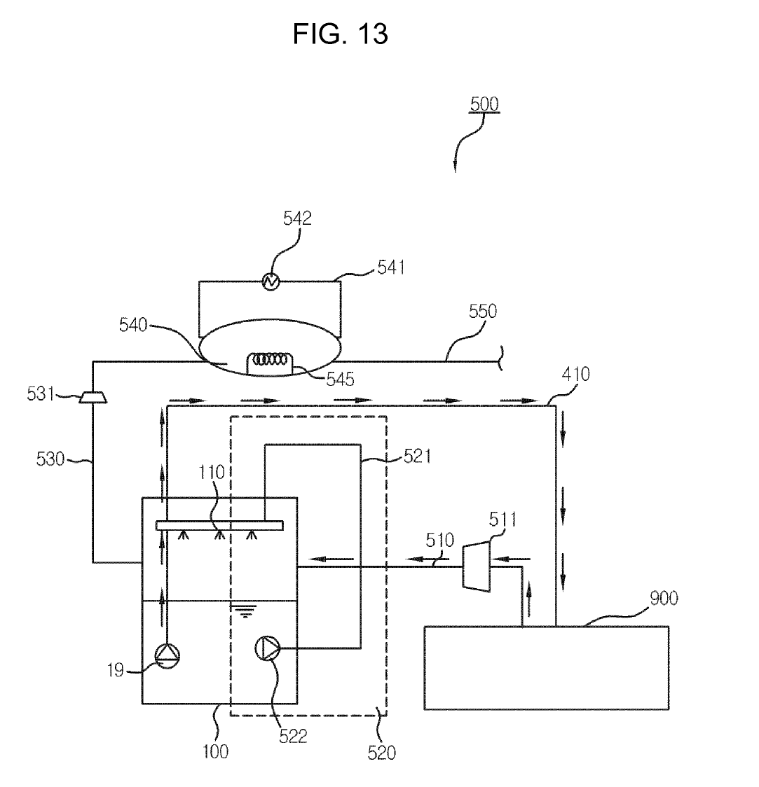

The boil-off gas treatment system 500 is a system which treats the boil-off gas generated from the ship fuel tank 900 and the boil-off gas treatment system 500 of the LNG refueling system 1000 according to the embodiment of the present invention will be first described with reference to FIG. 13.

The boil-off gas treatment system 500 according to the embodiment of the present invention is configured to include a first boil-off gas transfer tube 510 which transfers the boil-off gas generated from the ship fuel tank 900 to the low-temperature LNG tank 100 or the high-temperature LNG tank 200, an injection unit 520 which injects the ultralow temperature LNG to reduce the temperature of the transferred boil-off gas, a second boil-off gas transfer tube 530 which transfers the boil-off gas with the reduced temperature to an adsorbing-desorbing apparatus 540, and an adsorbing-desorbing apparatus 540 which selectively adsorbs and desorbs the boil-off gas depending on the temperature, and a third boil-off gas transfer tube 550 which transfers the boil-off gas desorbed from the adsorbing-desorbing apparatus 540.

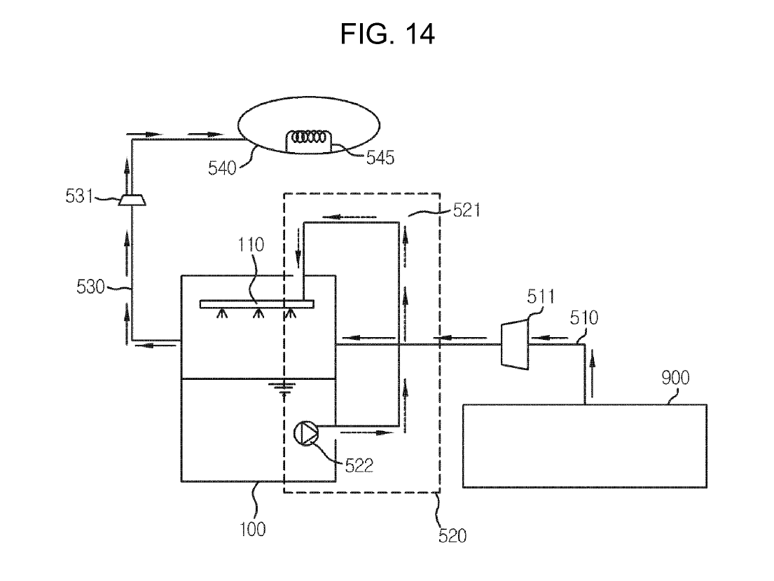

The adsorption of the boil-off gas by the operation of the injection unit 520 and the adsorbing-desorbing apparatus 540 will be described with reference to FIG. 14. As illustrated in FIG. 14, the first boil-off gas transfer tube 510 connects between the low-temperature LNG tank 100 or the high-temperature LNG tank 200 and the ship fuel tank 900 and transfers the boil-off gas in the ship fuel tank 900 to the low-temperature LNG tank 100.

In this case, the first boil-off gas transfer tube 510 includes a first compressor 511 to reduce the volume of the boil-off gas and increase the pressure so as to effectively transfer the boil-off gas generated from the ship fuel tank 900 to the low-temperature LNG tank 100 or the high-temperature LNG tank 200.

The injection unit 520 is an apparatus which may effectively reduce the temperature of the boil-off gas transferred into the low-temperature LNG tank 100 or the high-temperature LNG tank 200 through the first boil-off gas transfer tube 510 and as illustrated in FIG. 14, the ultralow temperature LNG stored in the low-temperature LNG tank 100 is injected into the low-temperature LNG tank 100 or the high-temperature LNG tank 200 by using an injection transfer tube 521 which is a separate bypass channel to mix the transferred boil-off gas with the injected LNG in the low-temperature LNG tank 100 or the high-temperature LNG tank 200, thereby reducing the temperature of the boil-off gas. In this case, the liquid-state LNG in the low-temperature LNG tank 100 or the high-temperature LNG tank 200 has a temperature lower than that of the boil-off gas which is a gas state, and therefore when the LNG is mixed with the boil-off gas, the temperature of the boil-off gas may be reduced.

The boil-off gas mixed with the LNG injected into the low-temperature LNG tank 100 or the high-temperature LNG tank 200 is transferred to the adsorbing-desorbing apparatus 540 through the second boil-off gas transfer tube 530 and the boil-off gas having the reduced temperature due to the mixing is effectively adsorbed by the adsorbing-desorbing apparatus 540.

The second boil-off gas transfer tube 530 includes a second compressor 531, such that the pressure of the transferred boil-off gas having the temperature controlled by the injection unit 520 is controlled by the second compressor 531.

The adsorbing-desorbing apparatus 540 includes an adsorbent which adsorbs and desorbs the boil-off gas depending on temperature and pressure and further includes a temperature control apparatus 545 which controls temperature at the time of adsorbing and desorbing.

Further, the adsorbing-desorbing apparatus 540 effectively performs the adsorption at low temperature and high pressure and effectively performs the desorption at high temperature and low pressure and if necessary, a plurality of adsorbing-desorbing apparatuses may be connected with each other.

In order to allow the adsorbing-desorbing apparatus 540 to effectively perform the desorption, the boil-off gas treatment system 500 includes a first desorption transfer tube 541 and a heating apparatus 542. The first desorption transfer tube 541 transfers a portion of the boil-off gas desorbed by the adsorbing-desorbing apparatus 540 and transfers the boil-off gas to the heating apparatus 542 included in the first desorption transfer tube 12. In this case, a portion of the desorbed boil gas is reintroduced into the adsorbing-desorbing apparatus 540 in the state which the temperature of the boil-off gas increases by passing through the heating apparatus 542 and thus the remaining adsorbed boil-off gas is desorbed by the adsorbing-desorbing apparatus 540. In order to desorb a portion of the boil-off gas, the configuration of the boil-off gas treatment system 500 is not limited to one method and therefore a plurality of embodiments may be present.

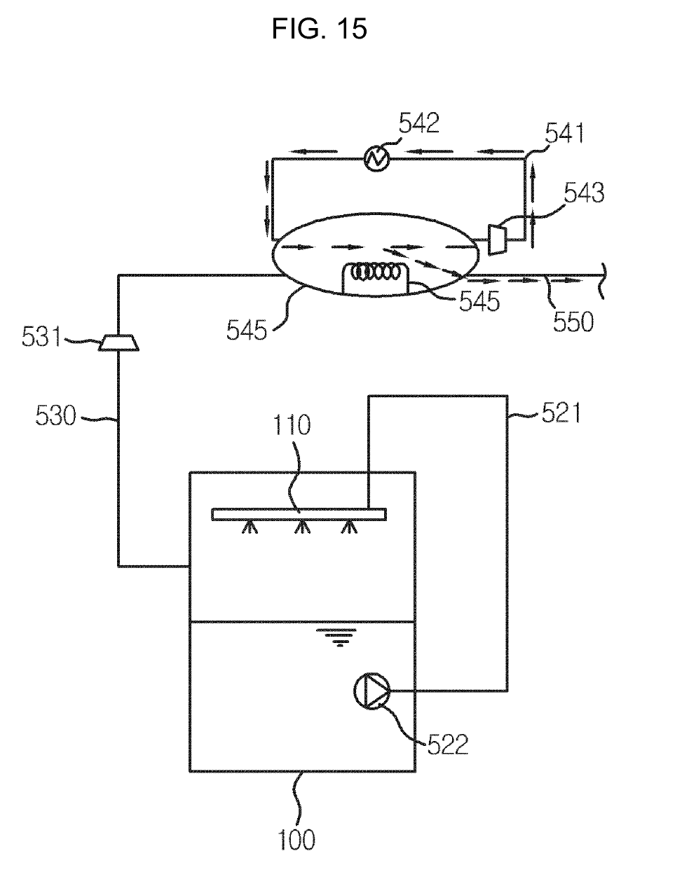

The boil-off gas treatment system 500 will describe the embodiment of the configuration for desorbing a portion of the boil-off gas with reference to FIG. 15.

As illustrated in FIG. 15, the boil-off gas treatment system 500 may include a vacuum pump 543 in the first desorbing transfer tube 541 and the vacuum pump 543 reduces the pressure in the adsorbing-desorbing apparatus 540 to desorb a portion of the boil-off gas.

As illustrated in FIG. 15, a portion of the desorbed boil-off gas is transferred to the heating apparatus 542 and thus has the increased temperature and the boil-off gas having the increased temperature is reintroduced into the adsorbing-desorbing apparatus 540 to increase the temperature in the adsorbing-desorbing apparatus 540, thereby performing the desorption.

The vacuum pump 543 desorbs a portion of the boil-off gas adsorbed into the adsorbing-desorbing apparatus 540 and the remaining adsorbed boil-off gas increases the temperature in the adsorbing-desorbing apparatus 540 by repeatedly circulating the desorbed boil-off gas plural times, thereby performing the desorption.

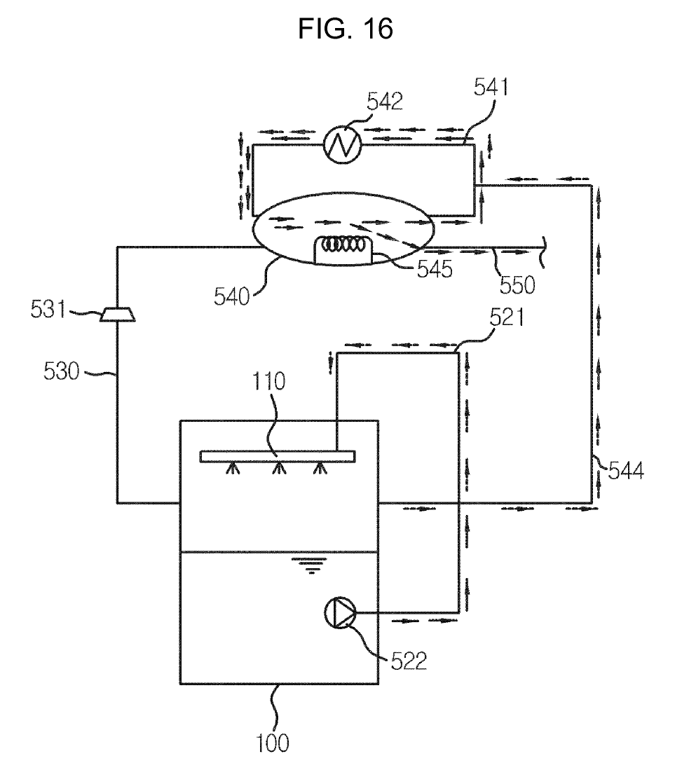

FIG. 16 is a schematic diagram illustrating the boil-off gas treatment system 500 of the LNG refueling system 1000 according to another embodiment of the present invention and the boil-off gas treatment system 500 according to another embodiment of the present invention may further include a second desorption transfer tube.

The boil-off gas treatment system 500 according to another embodiment of the present invention includes a second desorption transfer tube 544 having one end connected to one side of the low-temperature LNG tank or the high-temperature LNG tank 200 and the remaining end connected to the first desorption transfer tube 541 connecting between the adsorbing-desorbing apparatus 540 and the heating apparatus 542 and as illustrated in FIG. 16, the ultralow temperature LNG injected from the injection unit 520 and transferred through the second desorption transfer tube 544 is transferred to the heating apparatus 542. The LNG transferred to the heating apparatus 542 through the second desorption transfer tube 544 is introduced into the adsorbing-desorbing apparatus 540 in the state in which the temperature of LNG increases and the LNG having the temperature increasing by passing through the heating apparatus 542 increases the temperature in the adsorbing-desorbing apparatus 540 to desorb a portion of the boil-off gas adsorbed into the adsorbing-desorbing apparatus 540.

A portion of the desorbed boil-off gas is reintroduced into the adsorbing-desorbing apparatus 540 and the temperature thereof increases so as to allow the adsorbing-desorbing apparatus 540 to desorb the remaining adsorbed boil-off gas and the desorbed boil-off gas having temperature increasing by the adsorbing-desorbing apparatus 540 is transferred to be reused.

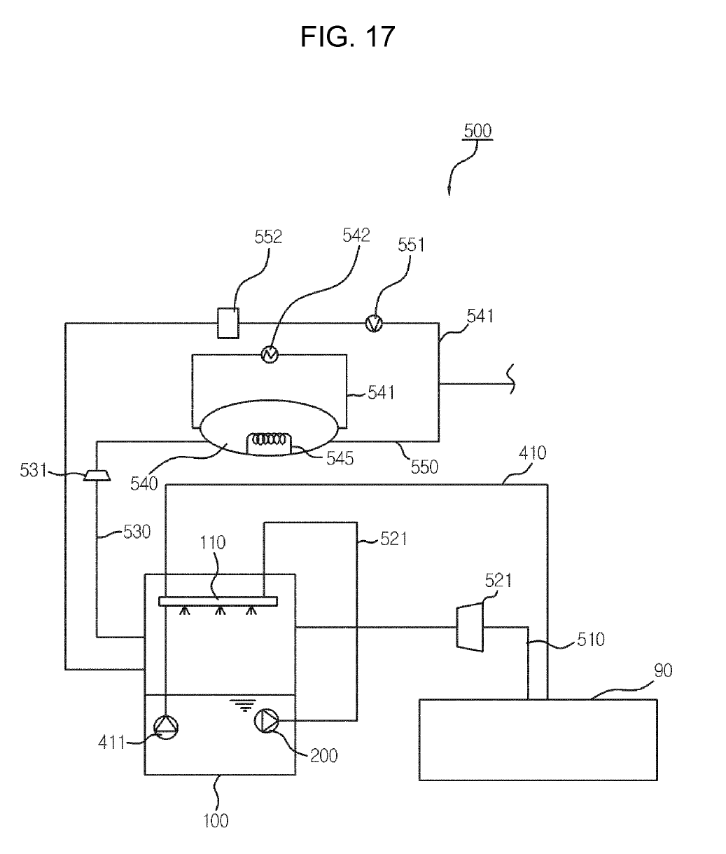

FIG. 17 illustrates the boil-off gas treatment system 500 of the LNG refueling system 1000 according to another embodiment of the present invention and the boil-off gas treatment system 500 according to another embodiment of the present invention further includes a cooling apparatus 551 reducing the temperature of the desorbed boil-off gas and a liquefying apparatus 552 re-liquefying the desorbed and cooled boil-off gas which are disposed on the third boil-off gas transfer tube 550.

The cooling apparatus 551 and the liquefying apparatus 552 are sequentially disposed in the third boil-off gas transfer tube 550 and one end of the third boil-off gas transfer tube 550 is connected to the low-temperature LNG tank 100 or the high-temperature LNG tank 200 to transfer the LNG re-liquefied by passing through the cooling apparatus 551 and the liquefying apparatus 552 to the low-temperature LNG tank 100. The re-liquefied LNG is used like the LNG in the low-temperature LNG tank 100 or the high-temperature LNG tank 200.

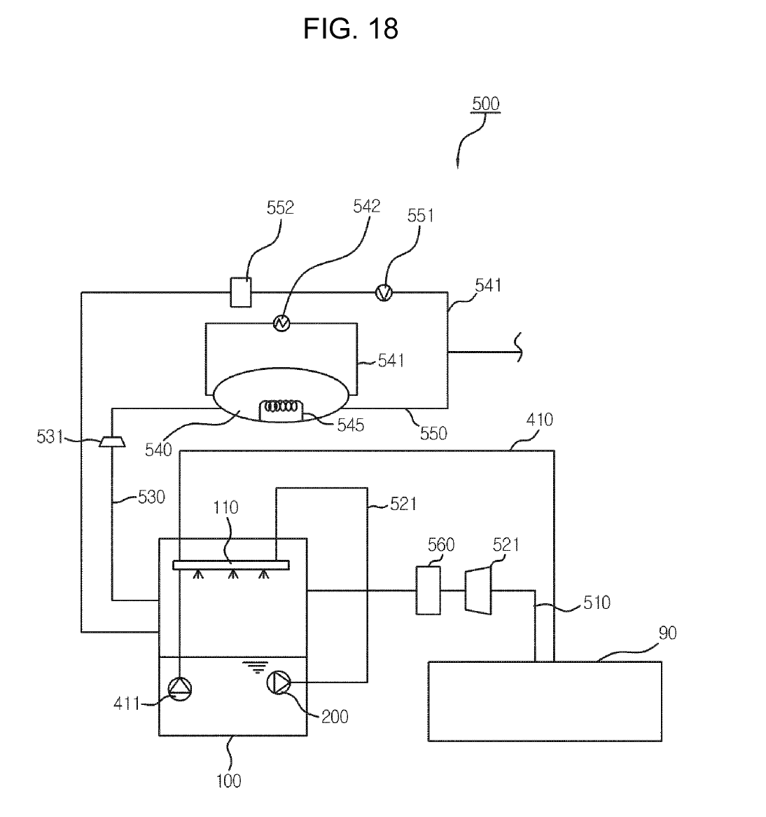

FIG. 18 is a schematic diagram illustrating the boil-off gas treatment system 500 of the LNG refueling system 1000 according to another embodiment of the present invention and the boil-off gas treatment system 500 according to another embodiment of the present invention further includes a temporary storage tank 560. When the boil-off gas is transferred from the ship fuel tank 900 to the low-temperature LNG tank 100 or the high-temperature LNG tank 200 through the first boil-off gas transfer tube 510, the temporary storage tank 560 is disposed on the first boil-off gas transfer tube 510 to temporarily store the boil-off gas. In this case, the temporary storage tank 560 is disposed between the low-temperature LNG tank 100 and the first compressor 521 to transfer the boil-off gas having the reduced volume by being compressed by the first compressor 521 to the temporary storage tank 560.

The boil-off gas treatment system 500 according to another embodiment of the present invention includes the temporary storage tank 560 between the ship fuel tank 900 and the low-temperature LNG tank 100 or the high-temperature LNG tank 200 and thus may withdraw the boil-off gas even after the ship fuel tank 900 from the low-temperature LNG tank 100. Therefore, the boil-off gas treatment may be performed simultaneously with the refueling to the ship fuel tank 900.

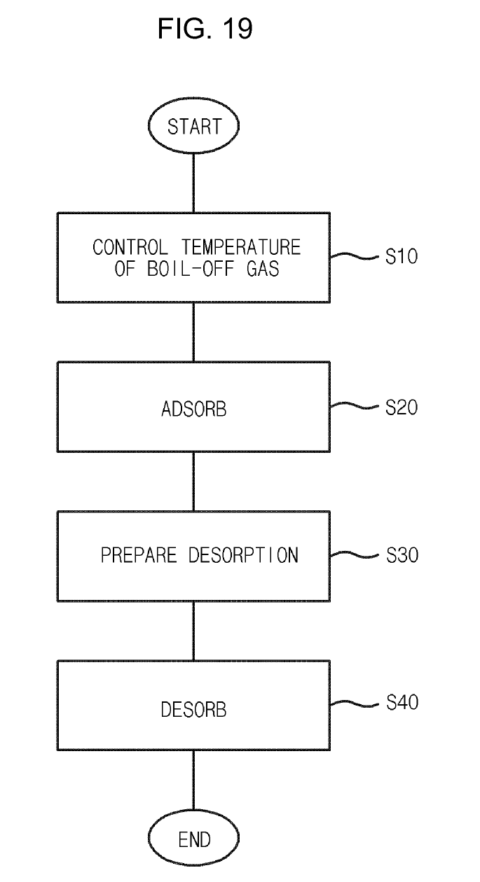

Meanwhile, in the LNG refueling system 1000 according to the present invention, a boil-off gas treatment method for allowing the boil-off gas generated during the refueling to be treated in the boil-off gas treatment system 500 will be described with reference to FIGS. 19 to 23.

The boil-off gas treatment method according to the present invention illustrated in FIG. 19 is performed by including controlling the temperature of the boil-off gas (S10), adsorbing (S20), preparing the desorption (S30), and desorbing (S40).

The controlling of the temperature of the boil-off gas (S10) is a step of reducing the temperature of the boil-off gas transferred from the ship fuel tank 900, which is a step of reducing the temperature of the high-temperature boil-off gas by mixing the high-temperature boil off gas with the ultralow temperature LNG injected from the injection unit 520.

The adsorbing (S20) is a step of adsorbing the boil-off gas with the reduced temperature in the controlling of the temperature (S10) into the adsorbing-desorbing apparatus 540, which is a step of transferring and adsorbing the boil-off gas with the reduced temperature to and into the adsorbing-desorbing apparatus 540 through the second boil-off gas transfer tube 530.

The preparing desorption (S30) is a step of desorbing a portion of the boil-off gas by controlling the temperature and the pressure of the adsorbed boil-off gas and the desorption method may be changed according to the above-mentioned embodiment and is performed using the boil-off gas treatment system 500 of each embodiment described above.

The desorbing (S40) is a step of desorbing the remaining adsorbed boil-off gas by using a portion of the boil-off gas adsorbed in the preparing desorption (S30), which is a step of introducing a portion of the desorbed boil-off gas into the adsorbing-desorbing apparatus 540 to increase the temperature in the adsorbing-desorbing apparatus 540 so as to desorb the remaining adsorbed boil-off gas.

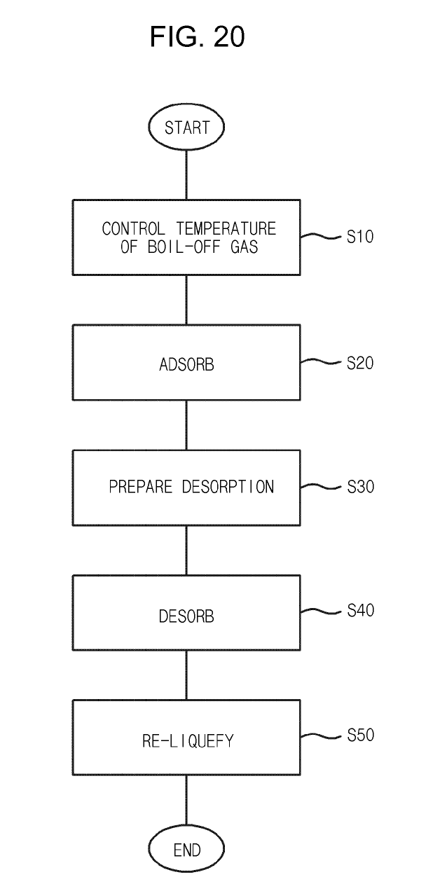

Further, another embodiment of the boil-off gas treatment method according to the present invention is illustrated in FIG. 20. The embodiment illustrated in FIG. 20 is the same as the boil-off gas treatment method illustrated in FIG. 19, but further performs re-liquefying (S50) after the desorbing (S40).

The re-liquefying (S50) is a step of re-liquefying the boil-off gas desorbed in the desorbing (S40), which is a step of making the desorbed boil-off gas be in the LNG state again by passing through the cooling apparatus 551 and the liquefying apparatus 552 as illustrated in FIG. 17 and transferring the desorbed boil-off gas to the low-temperature LNG tank 100 through the third boil-off gas transfer tube 550.

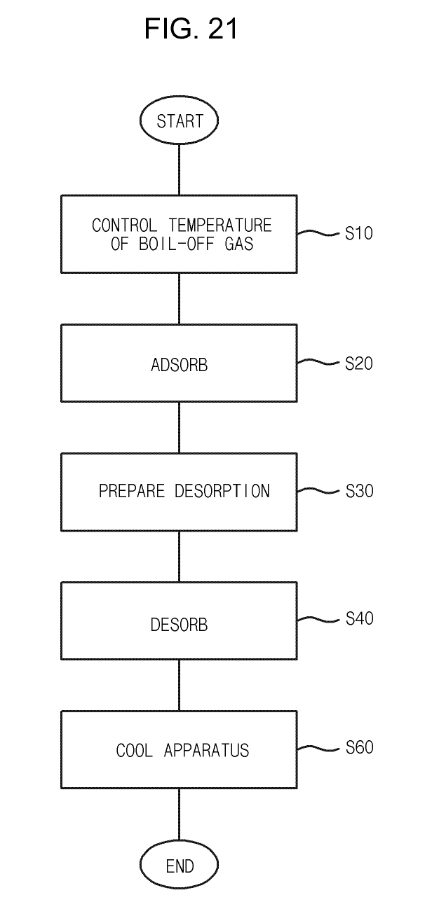

Further, another embodiment of the boil-off gas treatment method according to the present invention is illustrated in FIG. 21. The example illustrated in FIG. 21 is the same as the boil-off gas treatment method according to the embodiment of the present invention illustrated in FIG. 19, but further performs cooling an apparatus (S60) after the desorbing (S40).

The cooling apparatus (S60) is a step of cooling the adsorbing-desorbing apparatus 540 after all the steps are performed, which is a step of transferring the ultralow LNG injected from the injection unit 520 through the second boil-off gas transfer tube 530 to cool the adsorbing-desorbing apparatus 540.

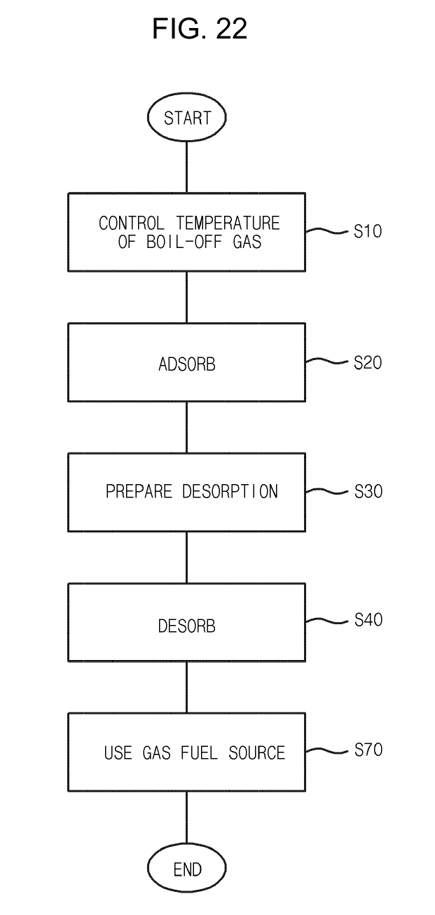

Further, another embodiment of the boil-off gas treatment method according to the present invention is illustrated in FIG. 22. The example illustrated in FIG. 22 is the same as the boil-off gas treatment method according to the embodiment of the present invention illustrated in FIG. 19, but further performs using a gas fuel source (S70) after the desorbing (S40). The using of the gas fuel source (S70) is a step of transferring and using the boil-off gas desorbed in the desorbing (S40) to a gas fuel source 910.

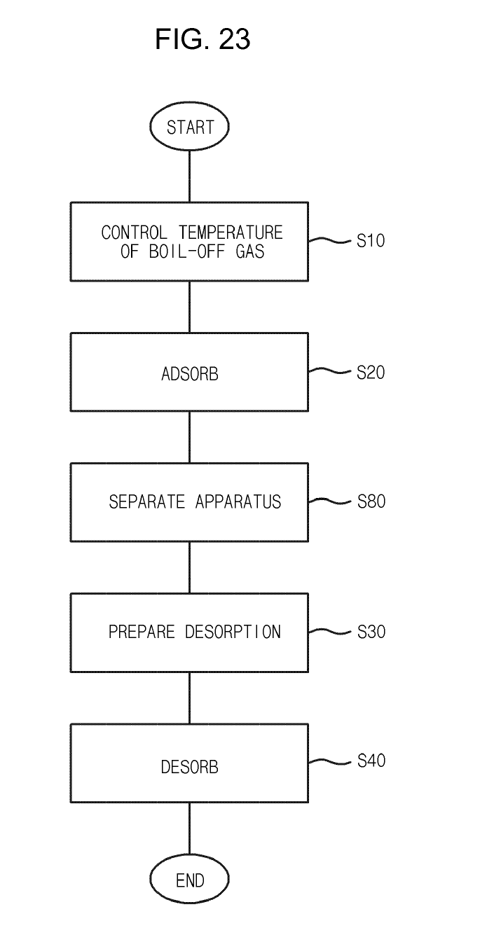

Further, another embodiment of the boil-off gas treatment method according to the present invention is illustrated in FIG. 23. The example illustrated in FIG. 23 is the same as the boil-off gas treatment method according to the embodiment of the present invention illustrated in FIG. 19, but further performs separating an apparatus (S80) after the adsorbing (S20). The separating apparatus (S80) is a step of separating the ship fuel tank 900 from the low-temperature LNG tank 100 or the high-temperature LNG tank 200. In this case, the boil-off gas treatment system 500 may preferably further include the temporary storage tank 560.

According to the boil-off gas treatment method treating the boil-off gas generated during the refueling in the LNG refueling system 1000 according to the present invention as described above, the boil-off gas can be efficiently reused and the energy used to treat the boil-off gas can be saved.

The present invention is not limited to the above-mentioned exemplary embodiments, and may be variously applied, and may be variously modified without departing from the gist of the present invention claimed in the claims.
1000: LNG refueling system
100: Low-temperature LNG tank 110: First injection apparatus
200: High-temperature LNG tank 210: Second injection apparatus
310: Natural gas compression system
320: Natural gas liquefyingsystem
330: LNG heating system
340: LNG flashing system 341: Flashing drum
342: Low-temperature LNG supplying pump 343: Flashing LNG pump
344: Valve 345: Pressure control valve
346: Pressure safety valve
350: Inert gas producing system
360: Inert gas-natural gas separating system
370: Power producing system
380: LNG boil-off system
410: First transfer tube 420: Second transfer tube
430: Third transfer tube 440: Fourth transfer tube
450: Fifth transfer tube 460: Sixth transfer tube
470: Seventh transfer tube 480: Exhaust gas main tube
481: Combustion apparatus
500: Boil-off gas treatment system 510: First boil-off gas transfer tube
511: First compressor 520: Injection unit
521: Injection transfer tube 522: Injection pump
530: Second boil-off gas transfer tube 531: Second compressor
540: Adsorbing-desorbing apparatus 541: First desorption transfer tube
542: Heating apparatus 543: Vacuum pump
544: Second desorption transfer tube 545: Temperature control apparatus
550: Third boil-off gas transfer tube 551: Cooling apparatus
552: Liquefying apparatus 560: Temporary storage tank
710: Internal power consumption source 720: External power consumption source
800: LNG carrier fuel tank 900: Ship fuel tank
910: Gas fuel source
S10˜S80: Each step of boil-off gas treatment method according to the present invention

1. An LNG refueling system, comprising:
at least one low-temperature LNG tank (100) delivering or introducing LNG from a ship fuel tank (900) on the sea;
at least one pressure vessel type high-temperature LNG tank (200) connected to the low-temperature LNG tank (100); and
a natural gas compression system (310) compressing natural gas generated from the low-temperature LNG tank (100) due to heat introduced from the outside and transferring the compressed natural gas to the high-temperature LNG tank (200).

2. The LNG refueling system of claim 1, further comprising:
a seventh transfer tube (470) transferring the LNG in the low-temperature LNG tank (100) to the high-temperature LNG tank (200).

3. The LNG refueling system of claim 1, wherein an inside of the low-temperature LNG tank (100) is provided with a first injection apparatus (110) and an inside of the high-temperature LNG tank (200) is provided with a second injection apparatus.

4. The LNG refueling system of claim 1, further comprising:
a natural gas liquefying system (320) liquefying the natural gas compressed by the natural gas compression system (310).

5. The LNG refueling system of claim 1, further comprising:
when the temperature of the LNG of the high-temperature LNG tank (200) is lower than that of the LNG requested from a ship, an LNG heating system (330) heating the LNG of the high-temperature LNG tank (200).

6. The LNG refueling system of claim 1, further comprising:
when a quantity of the LNG of the low-temperature LNG tank (100) is lower than that of the LNG requested from the ship, an LNG flashing system (340) flashing the LNG in the high-temperature LNG tank (200).

7. The LNG refueling system of claim 1, further comprising:
an inert gas producing system (350) and an inert gas-natural gas separating system (360) connected to the ship fuel tank (900).

8. The LNG refueling system of claim 1, further comprising:
a power producing system (370) connected to the low-temperature LNG tank (100) to combust the natural gas generated from the low-temperature LNG tank (100) so as to convert the combusted natural gas into electricity.

9. The LNG refueling system of claim 1, further comprising:
a fifth transfer tube (450) transferring the LNG from the LNG carrier fuel tank (800) to the low-temperature LNG tank (100) and the high-temperature LNG tank (200) and a sixth transfer tube (460) transferring the natural gas from the LNG carrier fuel tank (800) to the low-temperature LNG tank (100) and the high-temperature LNG tank (200).

10. The LNG refueling system of claim 1, further comprising:
a boil-off gas treatment system (500) treating boil-off gas generated when the LNG is transferred from the low-temperature LNG tank (100) to the ship fuel tank (900).

11. The LNG refueling system of claim 10, wherein the boil-off gas treatment system (500) includes:
a first boil-off gas transfer tube (510) connected between the low-temperature LNG tank (100) and the ship fuel tank (900) to transfer the boil-off gas generated from the ship fuel tank (900) to the low-temperature LNG tank (100) or the high-temperature LNG tank (200);
an injection unit (520) reducing the temperature of the boil-off gas in the low-temperature LNG tank (100);
a second boil-off gas transfer tube (530) connected to the low-temperature LNG tank (100) to transfer the temperature-controlled boil-off gas;
an adsorbing-desorbing apparatus (540) connected to an end of the second boil-off gas transfer tube (530) and including an adsorbent to selectively adsorb and desorb the boil-off gas; and
a third boil-off gas transfer tube (550) transferring the boil-off gas desorbed from the adsorbing-desorbing apparatus (540).

12.-26. (canceled)
